(19) United States
(12) Patent Application Publication
(10) Pub. No.: US 2009/0305061 A1
(43) Pub. Date: Dec. 10, 2009

(54) ELECTRODE AND METHOD FOR FORMING THE SAME AND SEMICONDUCTOR DEVICE

(75) Inventors: Hirotsugu Ishihara, Tokyo (JP); Masanobu Tanaka, Kanagawa (JP); Takahiro Kamei, Kanagawa (JP)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: SONY CORPORATION, Tokyo (JP)

(21) Appl. No.: 12/476,672

(22) Filed: Jun. 2, 2009

(30) Foreign Application Priority Data
Jun. 5, 2008 (JP) 2008-147717

(51) Int. Cl. B32B 15/04; B05D 5/12

(52) U.S. Cl. 428/446; 427/123

(57) ABSTRACT

An electrode includes a substrate, a contact layer, and a metal layer. The substrate has activated Si on the surface thereof. The contact layer includes a thin film (organic molecular film) made of an organic molecule having a first end with one of a CH group, a CH₂ group, and a CH₃ group and a second end with one of an amino group, a mercapto group, a phenyl group, and a carboxyl group. The thin film is formed on the surface of the substrate. A catalyst metal is applied to the surface of the organic molecular film. The metal layer is formed on the contact layer by an electroless plating process.

### BACKGROUND OF THE INVENTION

1. Field of the Invention

The present invention relates to an electrode formed on a Si base, such as a silicon substrate, by electroless plating and a method for forming such an electrode. The present invention also relates to a semiconductor device having such an electrode.

2. Description of the Related Art

Heretofore, in a process for manufacturing a semiconductor circuit, patterning of a metal layer has been performed by a photolithographic process along with the formation of the metal layer by a vacuum deposition process or a sputtering process. The photolithographic process forms a desired pattern on a metal layer by carrying out, for example, the steps of applying a photoresist material such as a photosensitive material to a substrate on which the metal layer has been formed, and exposing, developing, washing, and etching the metal layer.

In addition, a vacuum process, such as the above sputtering or vacuum deposition process can be used for the formation of an electrode on the surface of a single-crystal Si wafer, a polycrystalline (typically abbreviated as “poly”)-Si film, and an amorphous (typically abbreviated as “a”)-Si film to be used for a semiconductor device, such as a thin-film transistor (TFT).

Furthermore, there are other existing methods in the art. For example, there is a method for forming an electrode by electrolytic plating after the formation of a metal as an underlayer on a Si wafer. Alternatively, there is a method that includes the steps of washing the surface of Si with hydrofluoric acid or ammonium fluoride, applying a catalyst for electroless plating, such as Pd in palladium chloride solution, to the surface of Si, and forming a metal layer by electroless plating, or a method for solving the disadvantages of such a method (see Japanese Patent Laying-Open No. 2005-336600). Furthermore, there is another method that includes the steps of using a naturally oxidized film, a thermally oxidized film, a SiO₂ film formed by a vacuum process, or the like on a Si substrate to modify the surface thereof using a silane coupling agent, followed by the application of the above catalyst, and forming a metal layer by electroless plating.

Furthermore, there is another method by which Ni is directly deposited on Si by using an alkaline Ni metal-plating liquid (see Japanese Patent Laying-open No. 50-10734). Furthermore, there is still another method by which p-type or n-type Si is directly immersed in an electroless-plating liquid (for example, trade name “Rinden BSM-1”, manufactured by World Metal Co., Ltd.) after the removal of a naturally oxidized film on the surface of Si by using a dilute hydrofluoric acid solution or the like.

### SUMMARY OF THE INVENTION

However, the above method for forming a metal layer on Si by the above electroless plating uses a silane coupling agent and a metal such as palladium that acts as an electroless-plating catalyst. Thus, there is a disadvantage in this method. That is, the metal layer is often peeled off together with the silane coupling agent. This is because of a siloxane linkage between the silane coupling agent and the Si when the subsequent process includes the removal of an oxidized film with dilute hydrofluoric acid, ammonium fluoride, or the like. In addition, in the case of using a plating solution that can perform direct electroless plating on the above Si, silicide may be formed by heat treatment when it is used as an electrode. Thus, ohmic characteristics of the electrode can be easily obtained, but there is a limited selection of metal layers which can be formed. Furthermore, in most cases, it is difficult to form a metal film on undoped Si by electroless plating.

The present invention has been made in view of the above circumstances. It is desirable to provide an electrode using any kind of Si and metal layer without limitation and without causing peeling of a metal layer even being subjected to removal of an oxidized film from Si; a method for forming such an electrode; and a semiconductor device equipped with such an electrode.

For overcoming the above disadvantage, embodiments of the present invention are as described below.

According to an embodiment of the present invention, there is provided an electrode including: a substrate having activated Si on the surface thereof; a contact layer composed of a thin film (organic molecular film) made of an organic molecule having a first end with one of a CH group, a CH₂ group, and a CH₃ group and a second end with one of an amino group, a mercapto group, a phenyl group, and a carboxyl group, the thin film is formed on the surface of the substrate, and a catalyst metal applied to the surface of the organic molecular film; and a metal layer formed on the contact layer by an electroless plating process.

In the electrode, the organic molecule may have a molecular length of 10 nm or less.

In the electrode, furthermore, the organic molecular film may be a monomolecular film made of the organic molecule.

According to an embodiment of the present invention, there is provided a semiconductor device including an electrode. The electrode includes: a substrate, a contact layer, and a metal layer. The substrate has activated Si on the surface thereof; a contact layer composed of a thin film (organic molecular film) made of an organic molecule having a first end with one of a CH group, a CH₂ group, and a CH₃ group and a second end with one of an amino group, a mercapto group, a phenyl group, and a carboxyl group. The thin film is formed on the surface of the substrate. A catalyst metal is applied to the surface of the organic molecular film. Furthermore, a metal layer formed on the contact layer by an electroless plating process.

According to an embodiment of the present invention, there is provided a method for forming an electrode. The method includes the following steps: An organic molecular film is formed on a substrate having activated Si on the surface thereof. Here, the organic molecular film is a thin film made of an organic molecule having a first end with one of a CH group, a CH₂ group, and a CH₃ group and a second end with one of an amino group, a mercapto group, a phenyl group, and a carboxyl group. A catalyst metal is applied to the surface of the organic molecular film. A metal layer is formed on the surface of a contact layer, which is formed by applying the catalyst metal to the organic molecular film, by electroless plating.

In the method for forming an electrode, the organic molecule may have a molecular length of 10 nm or less.

In the method for forming an electrode, the organic molecular film may be a monomolecular film made of the organic molecule.

In the electrode according to the above embodiment of the present invention, the functional group on the first end of the organic molecule in the organic molecular film binds to the substrate to form a Si—C bond and the catalyst metal adsorbs to the functional group on the second end of the organic molecule. Therefore, the metal layer can be prevented from being peeled off even when the metal layer is subjected to the removal of an oxidized film with dilute hydrofluoric acid or ammonium fluoride. In addition, each of the above Si and the above metal layer is not limited to a particular one.

Also, the semiconductor device according to the embodiment of the present invention includes an electrode with favorable contact. Thus, in most case, the metal layer does not peel off from the electrode even when the electrode is subjected to removal of an oxidized film with dilute hydrofluoric acid or ammonium fluoride in the subsequent steps.

Furthermore, the method for forming an electrode according to the embodiment of the present invention can provide the metal layer with favorable contact without limiting the kind of Si in the substrate and the kind of the metal of the metal layer.

### BRIEF DESCRIPTION OF THE DRAWINGS

FIG. 1 is a flowchart representing a fundamental manufacturing process (1) in a method for forming an electrode according to an embodiment of the present invention, where FIG. 1A to FIG. 1D represent different steps in order;

FIG. 2 is a flowchart representing a fundamental manufacturing process (2) in a method for forming an electrode according to an embodiment of the present invention, where FIG. 2A to FIG. 2D represent different steps in order;

FIG. 3 is a flowchart representing a manufacturing process (1) for forming a metal layer with a predetermined pattern in a method for forming an electrode according to an embodiment of the present invention, where FIG. 3A to FIG. 3E represent different steps in order;

FIG. 4 is a flowchart representing a manufacturing process (2) for forming a metal layer with a predetermined pattern in a method for forming an electrode according to an embodiment of the present invention, where FIG. 4A to FIG. 4E represent different steps in order;

FIG. 5 is a flowchart representing a process (1) for fabricating a semiconductor device according to an embodiment of the present invention, where FIG. 5A to FIG. 5L represent different steps in order;

FIG. 6 is a flowchart representing a process (2) for fabricating a semiconductor device according to an embodiment of the present invention, where FIG. 6A to FIG. 6N represent different steps in order; and

FIG. 7 is a diagram representing the drain voltage (Vd)-drain electric current (Id) characteristic of Example 2.

### DESCRIPTION OF THE PREFERRED EMBODIMENTS

Hereinafter, the configuration of an electrode and a method for forming such an electrode and the configuration a semiconductor device having such an electrode according to embodiments of the present invention will be described. Although the present invention will be described with embodiments illustrated in the attached drawings, the present invention will be not limited to these embodiments and suitably modified depending on the embodiments. Any of embodiments will be within the scope of the present invention as long as they exert the operations and effects of the present invention.

An electrode according to an embodiment of the present invention includes a substrate, a contact layer, and a metal layer. The substrate is provided with activated Si on the surface thereof. The contact layer is composed of a thin film (organic molecular film) made of an organic molecule. Here, the organic molecule has a first end with one of a methine group (≡CH), a methylene group (═CH₂), and a methyl group (—CH₃) and a second end with one of an amino group (—NH₂), a mercapto group (—SH), a phenyl group (—Ph), and a carboxyl group (—COOH). The thin film is formed on the surface of the substrate. Furthermore, the catalyst metal is applied to the surface of the organic molecular film. The metal layer is formed on the contact layer by an electroless plating process.

Here, the substrate may be any of bulk and thin films as long as the surface thereof is provided with Si, irrespective of its crystalline state. Such bulk and thin films include a monocrystal Si wafer, a poly (polycrystalline)-Si thin film, and an a (amorphous)-Si thin film. In addition, the substrate may have an undoped Si-surface with high resistivity or an impurity-doped Si-surface with low resistivity. Furthermore, a naturally-occurring oxidized film may be removed from the surface of the substrate by a certain process. In other words, the surface of the substrate may be maintained as Si—H (water-repellent state) to allow the substrate to bind to an organic molecule described later.

Furthermore, the organic molecule in the organic molecular film has a chemical structure having first and second ends. The first end has one of a CH group, a CH₂ group, and a CH₃ group. The second end has an amino group (—NH₂), a mercapto group (—SH), a phenyl group (—Ph), and a carboxyl group (—COOH).

The Si—C bond of the functional group on the first end of the organic molecule to the above substrate is formed. In other words, such a bond is a direct one without intervention of oxygen, so that the bond will be hardly broken by a process for removal of an oxidized film. In addition, a catalyst metal (described later) is adsorbed to the functional group on the second end. Here, the bonding strength of the catalyst metal to the functional group varies in descending order: a mercapto group (—SH)>an amino group (—NH₂)>a phenyl group (—Ph)>a carboxyl group (—COOH), but any of these groups may be useful as long as it adheres to the metal layer.

Furthermore, the smaller the number of carbon atoms in the organic molecule, the better in consideration of the contact property of the organic molecule as an electrode (electron tunneling). In other words, the molecular length of the organic molecule which corresponds to the width of a tunnel barrier formed by the contact layer (the organic molecular film) is important for contact. Thus, the shorter the organic molecule the better. In the present embodiment, the organic molecule may have a molecular length of 10 nm or less, preferably 5 nm or less, more preferably 2 nm or less. Also, the organic molecular film may be preferably a monomolecular film made of the above organic molecule. Therefore, only the organic molecule strongly bound to Si on the surface of the substrate forms a contact layer. In addition, the surface of such a contact layer is in a state of being constructed of the above functional group of the second end.

In this embodiment, preferable examples of the organic molecule used include the following molecules (each of those marked with an asterisk (*) has a methylene linkage (═CH₂)):

(1) organic molecules with an amino group, such as 1-ethynyl cyclohexylamine (C₈H₁₃N), 2-ethynyl aniline (C₈H₇N), 3-ethynyl aniline (C₈H₇N), 4-ethynyl aniline (C₈H₇N) propargylamine (C₃H₅N), *acrylamide (C₃H₅NO), *allylamine (C₃H₇N),*1-allyl-2-thiourea (C₄H₈N₂S), *N-allyl aniline (C₉H₁₁N), *4-aminostyrene (C₈HgN), *2-vinyl-4,6-diamino-1,3,5-triazine (C₅H₇N₅), and phenylacetylene (C₈H₆);

(2) organic molecules with a phenyl group, such as ethynyl benzene (C₈H₆), 1-phenyl-2-propyne-1-ol (C₉H₈O), 4-phenyl-1-butyne (C₁₀H₁₀), *allyl benzyl ether (C₁₀H₁₂O), *allyl phenylsulfide (C₉H₁₀S), *allyl phenylsulfone (C₉H₁₀O₂S), *allyl diphenylphosphine oxide (C₁₅H₁₅OP), *2-allyloxy benzaldehyde (C₁₀H₁₀O₂), *vinyl benzoate (C₉H₈O₂), 2-isopropenyl toluene (C₁₀H₁₂), *2-isopropenyl naphthalene (C₁₃H₁₂), *benzyl methacrylate (C₁₁H₁₂O₂), *4-phenyl-1-butene (C₁₀H₁₂), *allyl benzene (C₉H₁₀), *phenylvinylsulfoxide (C₈H₈OS), *allyl phenylacetate (C₁₁H₁₂O₂), *phenylvinylsulfone (C₈H₁₈O₂S), *styrene (C₈H₈), and *triphenyl vinylsilane (C₂₀H₁₈Si);

(3) organic molecules with a mercapto group, such as *allyl mercaptan (C₃H₆S); and

(4) organic molecules with a carboxyl group, such as propiolic acid (C₃H₂O₂) and acrylic acid (C₃H₄O₂).

The above organic molecular film may be formed by low pressure chemical vapor deposition (LPCVD) or the like. Therefore, the monomolecular film can be easily formed.

A contact layer is formed by applying a catalyst metal to the organic molecular film. The catalyst metal is suitably selected from Pd, Ag, Pt, and so on as a catalyst metal that constitutes a metal layer formed by an electroless plating process. The catalyst metal may be applied to the contact layer by any of existing methods (for example, immersion of a substrate in a catalyst solution).

The metal layer is formed by an electroless plating process and functions as an electrode. Examples of a metal that constitutes the metal layer include Ni, Cu, Co, Au, and Pt, but the material of the metal layer is not limited thereto as long as it is an electrode material.

Therefore, in the electrode according to the embodiment of the present invention, the functional group on the first end of the organic molecular film binds strongly to the substrate by a Si—C bond without the presence of an oxygen atom (O) therebetween. In addition, the metal layer is formed by an electroless plating process via the catalyst metal adsorbed on the second end of the above organic molecular film. Therefore, both the contact layer and the metal layer can keep their favorable adhesiveness without being peeled off even if the electrode is subjected to the removal of an oxidized film with fluoric acid, ammonium fluoride, or the like.

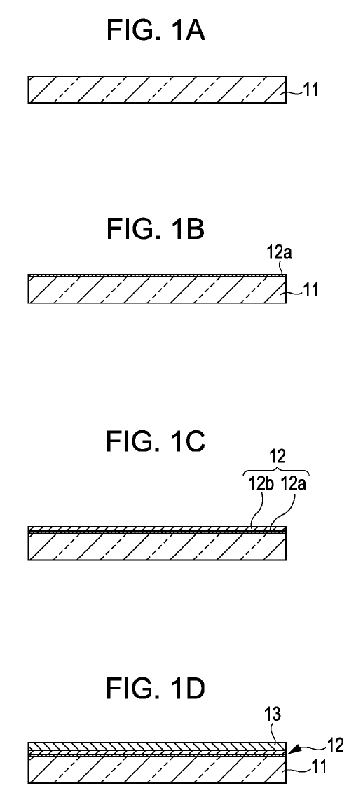

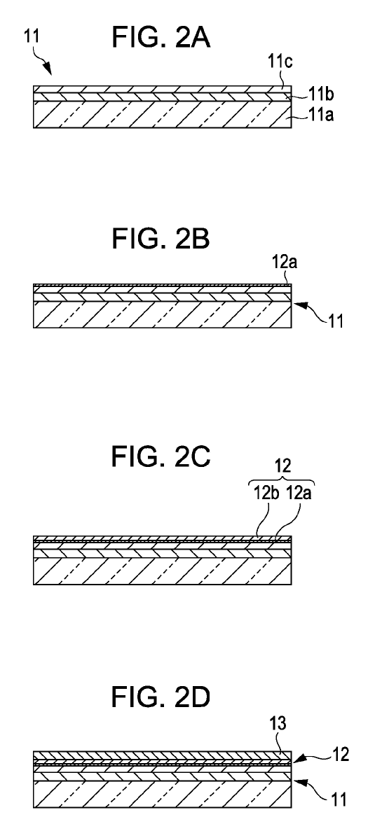

Referring now to FIG. 1 and FIG. 2, the fundamental processes of forming an electrode according to the embodiment of the present invention will be described. Here, in the process shown in FIG. 1, a Si wafer is employed as a substrate 11. In contrast, the substrate 11 used in FIG. 2 is one including an underlying substrate 11a made of glass or the like on which a Si thin film 11c is formed through an underlying protective film 11b.

(S11) The substrate 11 having Si on the surface thereof is subjected to an activation treatment to remove a naturally oxidized film (step for the removal of a naturally oxidized film, FIG. 1A and FIG. 2A). The activation treatment is performed, for example, by washing the surface of the substrate 11 with dilute hydrofluoric acid or ammonium fluoride.

(S12) Next, an organic molecular film 12a is formed using the organic molecule on the substrate 11 from which the naturally oxidized film has been removed, and the organic molecular film 12a is thus provided as a monomolecular film made of the organic molecules (step for the formation of an organic molecular film, FIG. 1B and FIG. 2B). For example, when the organic molecule used is 4-Ethynyl aniline (trade name, manufactured by Sigma Aldrich Co., Ltd.) with an amino group, the formation of a monomolecular film on the substrate may be performed using low pressure chemical vapor deposition. This is because 4-Ethynyl aniline is a material in powder form at room temperature and the melting point thereof is approximately 100° C. Needless to say, however, the organic molecule and the method for film formation are not limited to those described above. Any kind of organic molecule may be used as long as it can bind with Si to form a Si—C bond and has an amino group, a mercapto group, a phenyl group, a carboxyl group, or the like.

(S13) Next, a catalyst metal 12b is applied to the surface of an organic molecular film 12a (step for catalytic action, FIG. 1C and FIG. 2C). A catalyst is applied to the organic molecular film 12a by immersing the substrate 11, on which the organic molecular film 12a has been formed, in a palladium chloride solution that contains palladium to be used as a catalyst for electroless plating. Therefore, a contact layer 12 having the organic molecular film 12a provided with the catalyst metal 12b is formed.

(S14) Finally, a metal layer 13 is formed on the surface of the contact layer 12 by an electroless plating process (step for performing electroless plating, FIG. 1D and FIG. 2D). For example, the substrate 11 is immersed in an electroless plating solution to form a metal layer 13 on the area provided with the catalyst metal 12b. In this case, the ohmic value of the metal layer 13 formed by the electroless plating can be decreased by sintering the metal layer 13.

Consequently, the above process can form the metal layer 13 used as an electrode with suitable contact on the substrate 11.

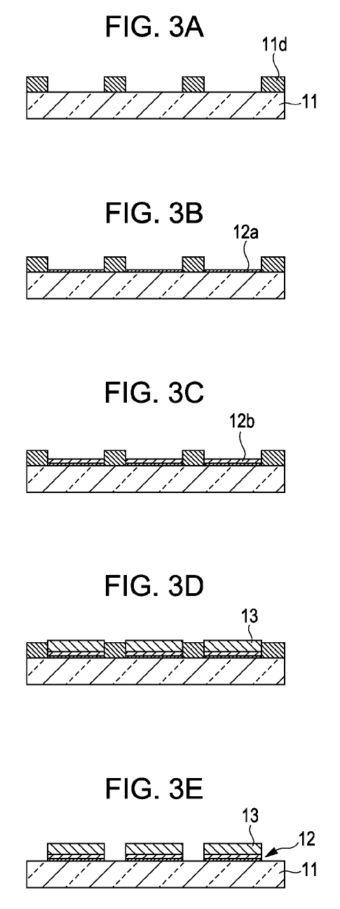

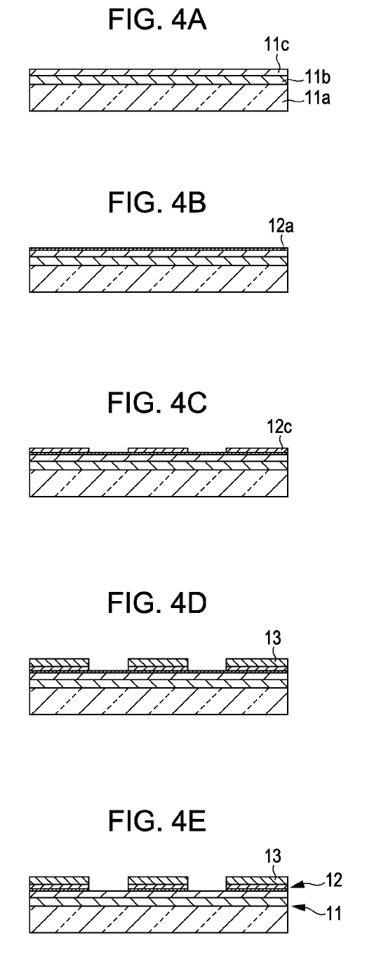

For patterning the metal layer 13 into a predetermined shape, as shown in FIG. 3 and FIG. 4, the substrate 11 may be subjected to predetermined treatments depending on the kind of the substrate 11.

In other words, in the case of the substrate 11 made of a Si wafer, an oxidized film made of SiO₂ or the like is formed on the surface of the substrate 11 and then subjected to patterning using a photoresist or the like to form a SiO₂ mask 11d (FIG. 3A). Subsequently, an organic molecular film is formed by the process illustrated in FIG. 1 (FIG. 3B). In this case, the organic molecular film 12a is formed on a Si-exposed area free of the mask 11d by binding to Si with a Si—C bond. After that, the substrate is provided with a catalyst metal 12b (FIG. 3C). In this case, the catalyst metal 12b is applied to only an area on which the organic molecular film 12a resides, forming the contact layer 12 with a predetermined pattern. Furthermore, the substrate 11 is immersed in an electroless plating solution to deposit a metal layer 13 only on an area where the contact layer 12 has been formed, or with a predetermined pattern.

If a particulate ink or the like containing gold, silver, palladium, or the like is used as a catalyst for electroless plating, the metal layer 13 may be patterned into a predetermined shape by patterning the catalyst layer using any of various printing methods or the like. An example of such a case is illustrated in FIG. 4. In this example, a step for removal of a naturally oxidized film (FIG. 4A) and a step for the formation of an organic molecular film are carried out in manners similar to those shown in FIG. 1 and FIG. 2. The above particulate ink containing the catalyst is then printed with a predetermined pattern on the surface of the organic molecular film 12a (step for catalyst printing, FIG. 4C). Subsequently, the substrate 11 is immersed in an electroless plating solution to deposit a metal layer 13 only on an area on which the catalyst layer 12c has been formed, or with a predetermined pattern (FIG. 4D). Subsequently, the organic molecular film 12a is removed from the area free of the metal layer 13 (FIG. 4E). Similarly, the above process for the formation of the metal layer 13 is also applicable when the substrate 11 is a Si wafer.

Next, a semiconductor device according to an embodiment of the present invention will be described.

The semiconductor device according to the present embodiment includes an electrode. The electrode is constructed of a substrate, a contact layer, and a metal layer. The substrate is provided with activated Si on the surface thereof. The contact layer is composed of a thin film made of an organic molecule. Here, the organic molecule has a first end with one of a CH group, a CH₂ group, and a CH₃ group and a second end with one of an amino group, a mercapto group, a phenyl group, and a carboxyl group. The thin film is formed on the surface of the substrate. Furthermore, the catalyst metal is applied to the surface of the organic molecular film. The metal layer is formed on the contact layer by an electroless plating process.

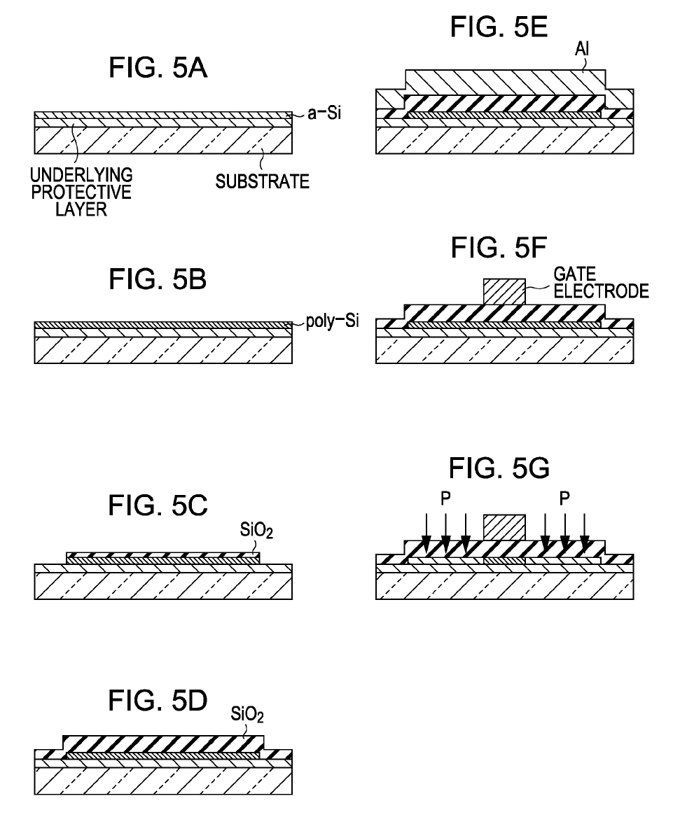

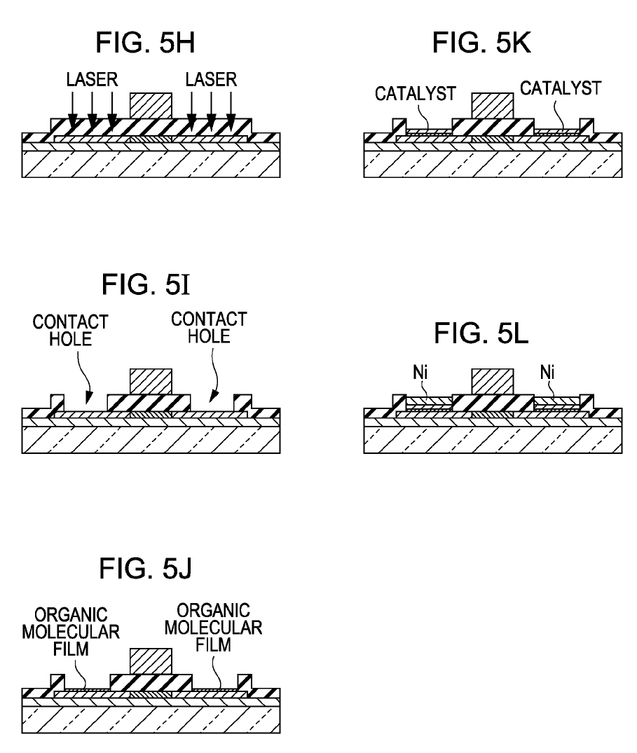

Referring now to FIG. 5, a specific example of a process for fabricating a semiconductor device will be described. Here, the process described below is one including the formation of an electrode as a source/drain (S/D) electrode of a top-gate type poly-Si thin film transistor (TFT).

The process is as follows: First, as shown in FIG. 5, both an underlying protective film (SiO₂) and a Si thin film (a-Si) are formed on a substrate made of glass (FIG. 5A). The Si thin film is then poly-crystallized using an excimer laser or the like to obtain a poly-Si film (FIG. 5B).

Next, after forming a SiO₂ layer on the surface of the poly-Si film, the poly-Si film is etched to form a channel region and a source-drain region (FIG. 5C). Then, a SiO₂ film to be used as a gate insulating film is formed on the surface of the poly-Si film (FIG. 5D). Subsequently, aluminum (Al) is deposited or sputtered on the entire surface of the substrate to form an Al film to be provided as a gate electrode of the TFT (FIG. 5E), and then patterned using a photoresist (FIG. 5F).

After this, a high concentration of phosphorus (P) is doped in the source-drain region by ion implantation (FIG. 5G). The doped portion is activated by an excimer layer (FIG. 5H) and a gate insulating film is then simply etched to form a contact hole (FIG. 5I). Alternatively, in this case, the gate insulating film may be etched using dilute hydrofluoric acid or ammonium fluoride as will be described in Example 2 below.

Next, using the above process illustrated in FIG. 2, an organic film is formed on the surface of Si (FIG. 5J) and then subjected to a catalyst treatment (FIG. 5K). The substrate having such an organic film is immersed into an electroless plating solution and then sintered to form a source/drain electrode (Ni) (FIG. 5L). Here, a LDD structure is not introduced in the semiconductor device of the present embodiment.

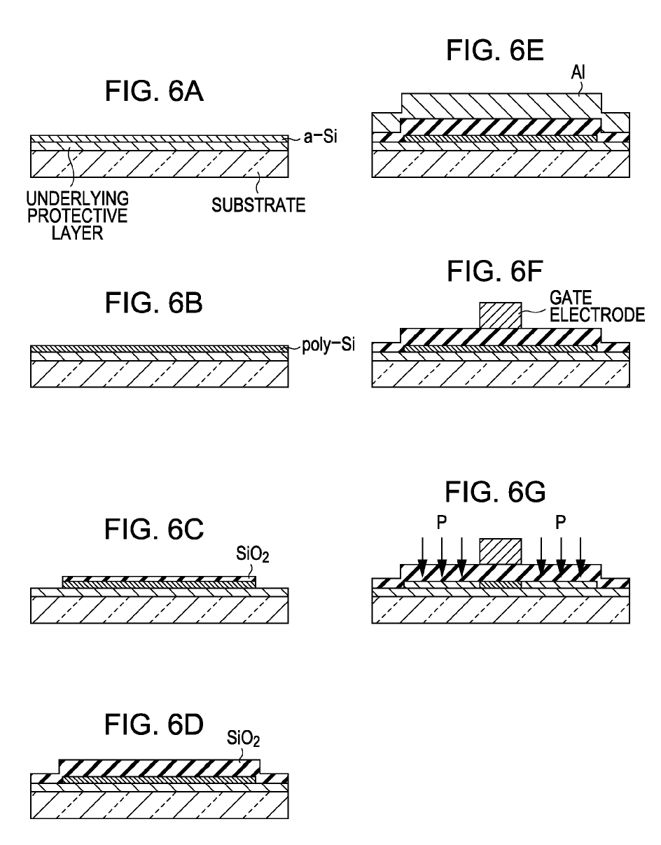

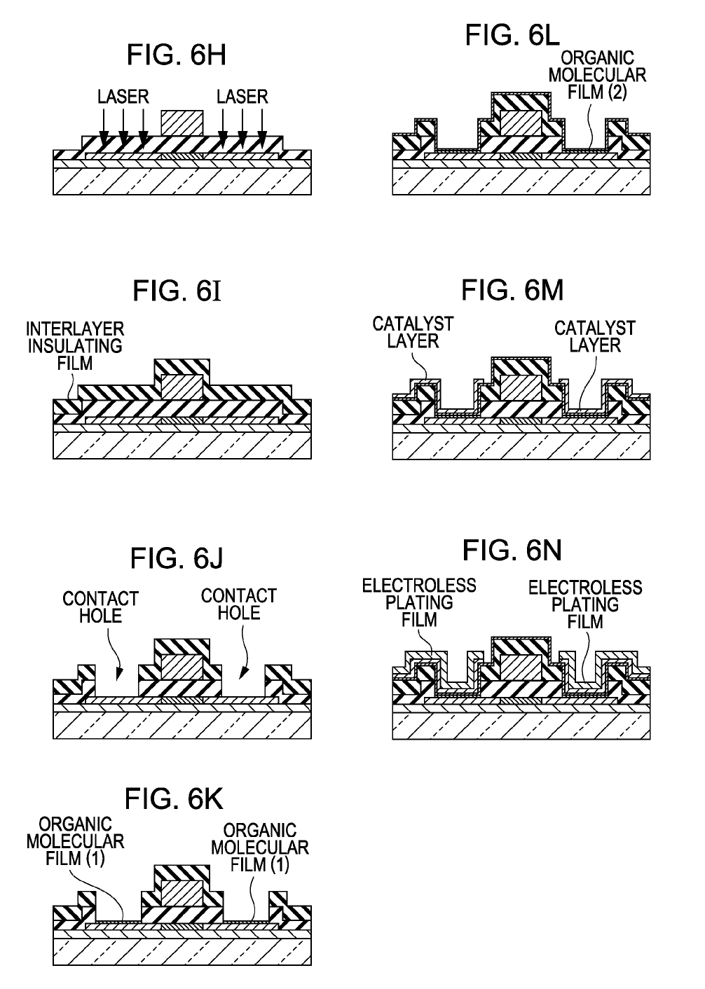

Furthermore, in the case of an actual top gate-type poly-Si TFT, an insulating interlayer may be formed before the formation of a contact hole. FIG. 6 illustrates a process for fabricating a semiconductor device with such an insulating interlayer.

In this case, FIG. 6A to FIG. 6H illustrate the same configurations as those of FIG. 5A to FIG. 5H. After performing the steps illustrated in FIG. 6A to FIG. 6H, an insulating interlayer is formed on the resulting substrate (FIG. 6I). A contact hole is then patterned on the insulating interlayer using a photoresist or the like (FIG. 6J). First, an organic molecular film (1) such as one made of 4-ethynyl aniline is formed on Si being exposed through the contact hole to form a Si—C bond, followed by being washed (FIG. 6K).

Next, a silane coupling agent (such as aminosilane) is deposited on the insulating interlayer made of SiO₂ or the like and formed as an organic molecular film (2) by a gas phase process (FIG. 6L).

After that, any of various printing methods is employed to print a catalyst layer on a desired portion (FIG. 6M) and the substrate is then immersed in an electroless plating solution. Therefore, a metal layer with satisfactory contact can be formed in a predetermined pattern on both Si and SiO₂ (FIG. 6N).

In the above embodiment, the top gate-type poly-Si TFT has been described by way of illustration. However, the present embodiment is not limited to such a kind of semiconductor device. Any other kind of semiconductor device can be fabricated using the method of forming an electrode according to any embodiment of the present invention.

### EXAMPLES

Hereinafter, experiments will be described. These experiments were carried out for verifying the advantages of the method of forming an electrode according to any embodiment of the present invention.

### Example 1

An electrode was fabricated by the process illustrated in each of FIG. 1 and FIG. 2.

The materials used in the process are as follows:
Substrates 11: one is a Si wafer in FIG. 1 and the other is a substrate composed of a glass substrate 11a and a Si thin film (a-Si thin film) 11c on the glass substrate 11a through an underlying protective film 11b in FIG. 2
Organic molecule material; 4-Ethynyl aniline (trade name, manufactured by Sigma-Aldrich Co., Ltd.)

### (Procedures for Formation of Electrode)

(S21) A naturally oxidized film was removed from the surface of a substrate 11 by washing with dilute hydrofluoric acid or ammonium fluoride.

(S22) Next, using the above organic molecular material, an organic molecular film 12a, which is a monomolecular film of such an organic molecule, was formed on the substrate 11 free of the naturally oxidized film. Here, 4-Ethynyl aniline is a material in powder form at room temperature and the melting point thereof is approximately 100° C. Thus, low pressure chemical vapor deposition (LPCVD) was employed for forming the monomolecular film on the substrate 11. That is, the above 4-Ethynyl aniline powder and the substrate 11 free of the naturally oxidized film were placed in a simple vacuum oven and then retained therein until the inner pressure of the vacuum oven reached an attainable pressure (1.325 kPa or less). After reaching the attainable pressure, a valve connected to the rotary pump was closed to make the inside of the vacuum oven be under reduced pressure. Next, the inside of the vacuum oven was heated with the heater (heated at 150° C.) to dry off 4-Ethynyl aniline under reduced pressure, thereby forming an organic molecular film on the Si surface of the substrate 11. The time taken for formation of a film was several hours to ten and several hours. Subsequently, the vacuum oven was returned to room temperature and the inside thereof was then opened to the air. The substrate 11 was then taken out of the vacuum oven. The substrate 11 was washed by ultrasonic cleaning with an organic solvent such as toluene or ethanol and then washed with pure water, followed by being dried to remove a fee organic molecule that had not been bound to Si. Therefore, the monomolecular film (organic molecular film) 12a of the organic molecule was formed on the substrate 11. The formation of the organic molecular film 12a was confirmed by evaluating a static contact angle of the Si surface with respect to water. In addition, the thickness of the organic film 12a was approximately 1.5 nm when measured using an atomic force microscope (AFM).

(S23) Next, the substrate was immersed in a palladium chloride solution, Activator (trade name, manufactured by Okuno Chemical Industries Co., Ltd.) for 1 to 3 minutes, and then washed with pure water and dried. The organic molecular film 12a was provided with Pd as a catalyst metal 12b, thereby forming a contact layer 12.

(S24) Ni—B was deposited on the contact layer 12 by immersing the substrate 11 in an electroless plating solution (trade name: BEL801, manufactured by C. Uyemura Co., Ltd.) capable of depositing Ni—B. At this time, the thickness of the metal layer 13 was adjusted to be approximately 200 nm by controlling the duration of immersion in the electroless plating solution. Subsequently, the substrate 11 was washed with pure water after being immersed in the electroless plating solution, and then dried over dry nitrogen (N₂). Finally, the Ni—B deposited substrate 11 was sintered at 350° C. for 30 to 60 minutes in a vacuum chamber and then provided as a sample.

The metal layer 13 of the sample thus obtained was examined and exhibited a low ohmic value. Furthermore, the sample was immersed in dilute hydrofluoric acid or ammonium fluoride solution and then subjected to a tape-peeling test.

However, the metal layer 13 did not exfoliate from the surface of Si (substrate 11). It was confirmed that the substrates had favorable contact, including the Si wafer and the substrate constructed of the glass substrate 11a and the Si thin film (a-Si thin film) 11c formed on the glass substrate 11a through the underlying protective film 11b.

### Example 2

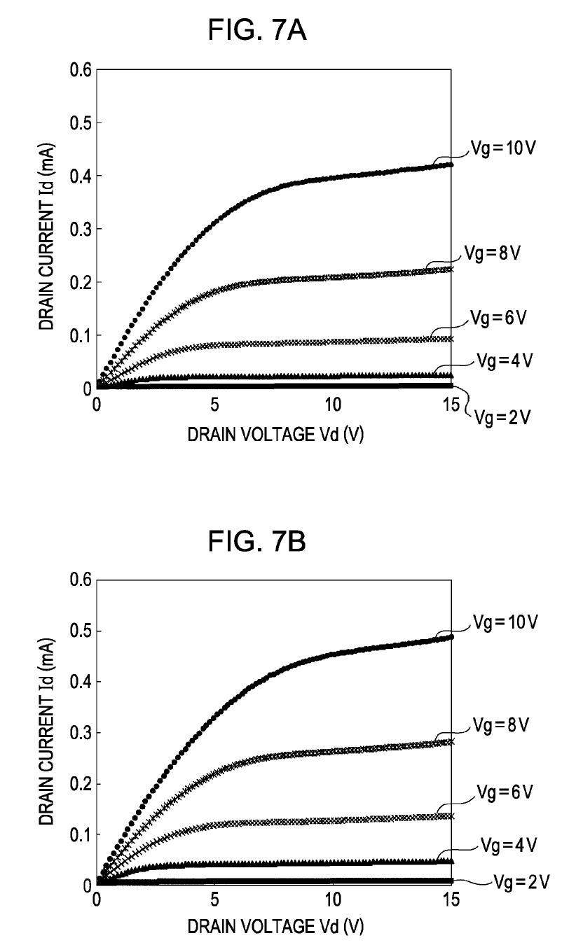

The relationship between drain voltage (Vd) and drain current (Id) of the semiconductor device, the poly-Si thin film transistor (TFT), fabricated by the procedures illustrated in FIG. 5 was investigated. The results are shown in FIG. 7. FIG. 7A represents the results obtained using the sample of the present example and FIG. 7B represents the results obtained using a comparative example. Here, the conditions of the sample of the present example were as follows:
TFT configuration: Top gate-type poly-Si TFT (double gate type, L=10 μm×2, W=50 μm)
Gate insulating film: SiO₂ (100 nm in thickness)
Gate electrode: Al (300 nm in thickness)
Source/drain electrode: The same conditions as those of Example 1 (100 nm in thickness).

In contrast, the sample of the comparative example was prepared under the same conditions as those of the present example except that the gate electrode of the comparative example was made of Al and the source/drain electrode was made of Al.

The results of the evaluation showed that the drain voltage (vd)−drain current (Id) characteristic of the TFT of the present example was not affected by the contact layer 12 and was favorable because the drain current was maintained low.

The present application contains subject matter related to that disclosed in Japanese Priority Patent Application JP 2008-147717 filed in the Japanese Patent Office on Jun. 5, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An electrode comprising:
a substrate having activated Si on the surface thereof;
a contact layer composed of a thin film (organic molecular film) made of an organic molecule having a first end with one of a CH group, a CH₂ group, and a CH₃ group and a second end with one of an amino group, a mercapto group, a phenyl group, and a carboxyl group, where said thin film is formed on the surface of said substrate, and a catalyst metal applied to the surface of said organic molecular film; and
a metal layer formed on said contact layer by an electroless plating process.

2. The electrode according to claim 1, wherein
said organic molecule has a molecular length of 10 nm or less.

3. The electrode according to claim 1 or 2, wherein
said organic molecular film is a monomolecular film made of said organic molecule.

4. A semiconductor device comprising an electrode that includes:
a substrate having activated Si on the surface thereof;
a contact layer composed of a thin film (organic molecular film) made of an organic molecule having a first end with one of a CH group, a CH₂ group, and a CH₃ group and a second end with one of an amino group, a mercapto group, a phenyl group, and a carboxyl group, where said thin film is formed on the surface of said substrate, and a catalyst metal applied to the surface of said organic molecular film; and
a metal layer formed on said contact layer by an electroless plating process.

5. A method for forming an electrode, comprising the steps of:
forming an organic molecular film on a substrate having activated Si on the surface thereof, where said organic molecular film is a thin film made of an organic molecule having a first end with one of a CH group, a CH₂ group, and a CH₃ group and a second end with one of an amino group, a mercapto group, a phenyl group, and a carboxyl group;
applying a catalyst metal to the surface of said organic molecular film; and
forming a metal layer on the surface of a contact layer, which is formed by applying said catalyst metal to said organic molecular film, by electroless plating.

6. The method for forming an electrode according to claim 5, wherein
said organic molecule has a molecular length of 10 nm or less.

7. The method for forming an electrode according to claim 5 or 6, wherein
said organic molecular film is a monomolecular film made of said organic molecule.
